(19) United States
(12) Patent Application Publication
(10) Pub. No.: US 2009/0308527 A1
(43) Pub. Date: Dec. 17, 2009

(54) Method For Fabricating Circuit Trace On Core Board Having Buried Hole

(76) Inventors: Chien-Wei Chang, Taoyuan (TW); Ting-Hao Lin, Taipei (TW); Bo-Yu Tseng, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/137,553

(22) Filed: Jun. 12, 2008

(51) Int. Cl. B32B 38/10

(52) U.S. Cl. 156/247

(57) ABSTRACT

A method for fabricating a circuit trace on a core board having a buried hole is provided. The method includes: providing a carrier plate having a detachable metal layer, an etching barrier layer, and a metal layer sequentially stacked thereon; roughening the metal layer which can be completely roughened; laminating the bonded metal layer, the etching barrier layer, the detachable metal layer and the carrier plate onto a dielectric, wherein the metal layer faces and contacts with the dielectric; and then removing the carrier plate therefrom. As such, even if the dielectric is difficult to be completely roughened, the roughened metal layer can enhance the bondability between the metal layer and the dielectric. The metal layer is processed to become the circuit trace later.

### BACKGROUND OF THE INVENTION

1. Field of the Invention

The present invention relates generally to a method for fabricating a circuit layer, and in particular to a method for fabricating a circuit trace on a thick core board having a buried hole.

2. The Prior Arts

A core board is used to mechanically support and electrically connect electronic components. The core board is made by laminating a copper layer onto a side of a substrate, removing unwanted copper, and then leaving a desired copper circuit trace. Sometimes, the core board has the circuit traces on both sides thereof.

The copper layer is laminated onto the substrate, and some temporary layers are bonded or electroplated onto the copper layer in sequence. Then the unwanted copper is removed by acid etching to create circuit traces on the substrate. However, splitting or peeling off between layers is likely to occur if bonding between the layers is not secure. Thus, a roughening processing or a passivation processing is applied on the surfaces of the layers, so the next layer can be securely bonded or electroplated on the previous layer.

Before the copper layer is laminated on the substrate, the substrate is usually subject to the roughening processing. A rough copper plate is pressed against the substrate so as to roughen a surface of the substrate. However, the copper plate, which is used to roughen the surface of the substrate, is too thick to be the copper layer of the core board. Therefore, the copper plate is removed, and electroless copper plating etc. is applied on the roughened surface of the substrate. Unfortunately, the bonding between electroless plating copper and the substrate is not strong enough, especially when the substrate is made of a material that is hard to roughen. In such a way, peeling off or splitting is likely to happen between the substrate and the copper layer laminated thereon.

### SUMMARY OF THE INVENTION

A primary objective of the present invention is to provide a method for fabricating a circuit trace on a thick core board having a buried hole. The method provides a roughened metal layer, which is processed to be a circuit layer later, to enhance bonding between the circuit layer and a dielectric. Thus, the method prevents the circuit layer from peeling off from the dielectric.

In order to achieve the aforementioned objective, a method for fabricating a circuit trace on a core board having a buried hole according to the present invention includes the steps of: providing a carrier plate, forming a detachable metal layer on the carrier plate, forming an etching barrier layer on the detachable metal layer, and forming a metal layer that can be completely roughened on the etching barrier layer; roughening the metal layer; laminating the carrier plate having the detachable metal layer, the etching barrier layer, and the metal layer onto a dielectric, wherein the metal layer contacts with the dielectric; and removing the carrier plate therefrom. The metal layer will be processed to be a circuit layer later. As such, even if the dielectric is hard to completely roughened, the roughened metal layer provides a rough surface to improve the bondability between the circuit layer and the dielectric.

### BRIEF DESCRIPTION OF THE DRAWINGS

The present invention will be apparent to those skilled in the art by reading the following detailed description of a preferred embodiment thereof, with reference to the attached drawings, in which:

FIGS. 1A through 1L are schematic diagrams illustrating steps of a method for fabricating a circuit trace on a core board having a buried hole according to the present invention.

### DETAILED DESCRIPTION OF THE PREFERRED EMBODIMENT

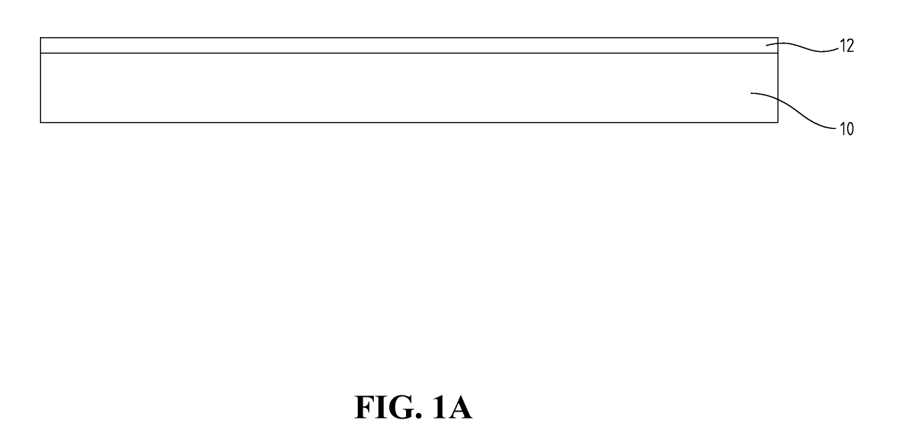

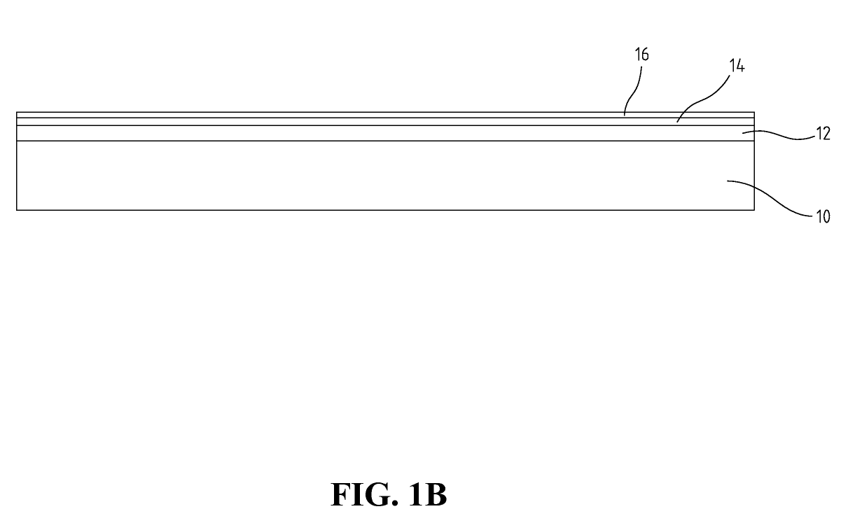

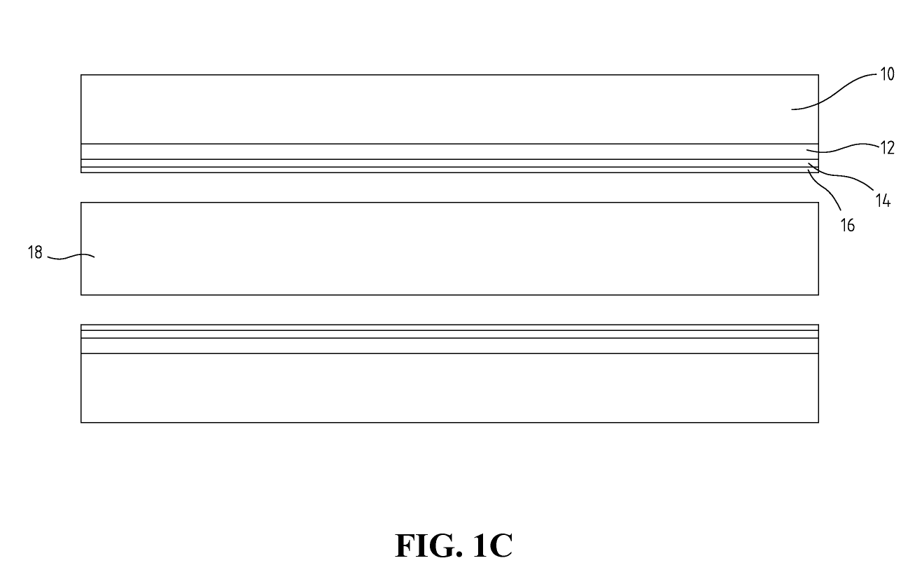

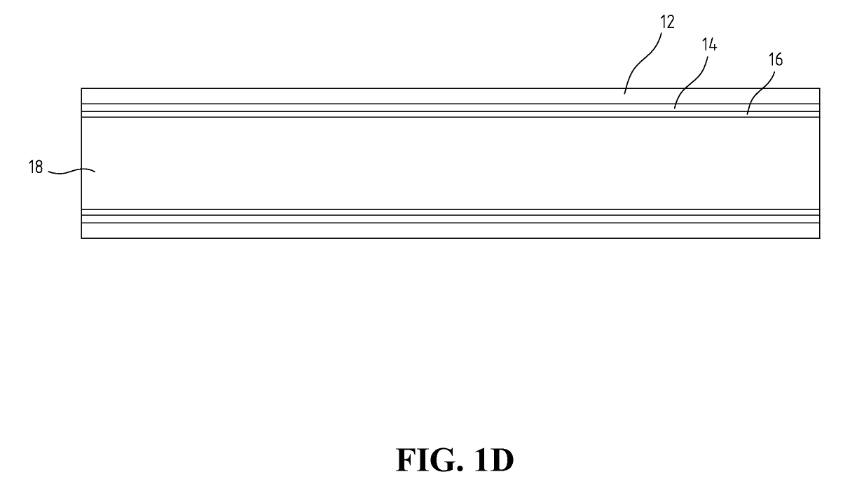

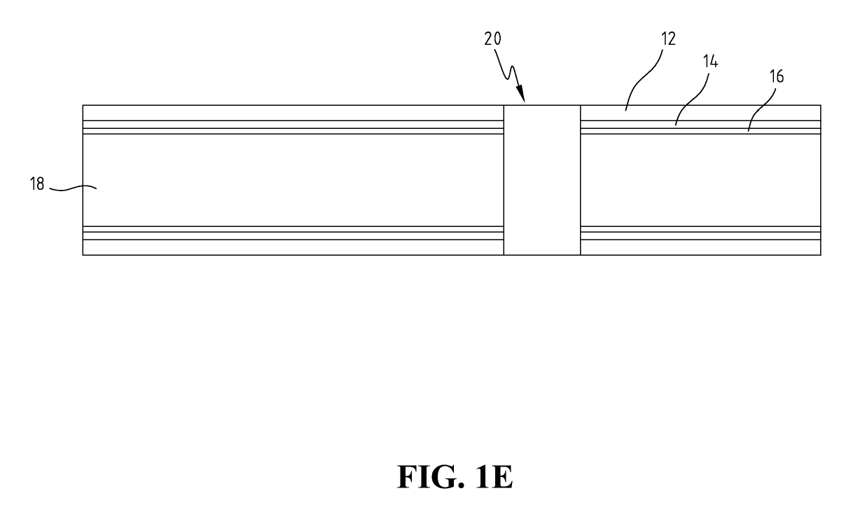

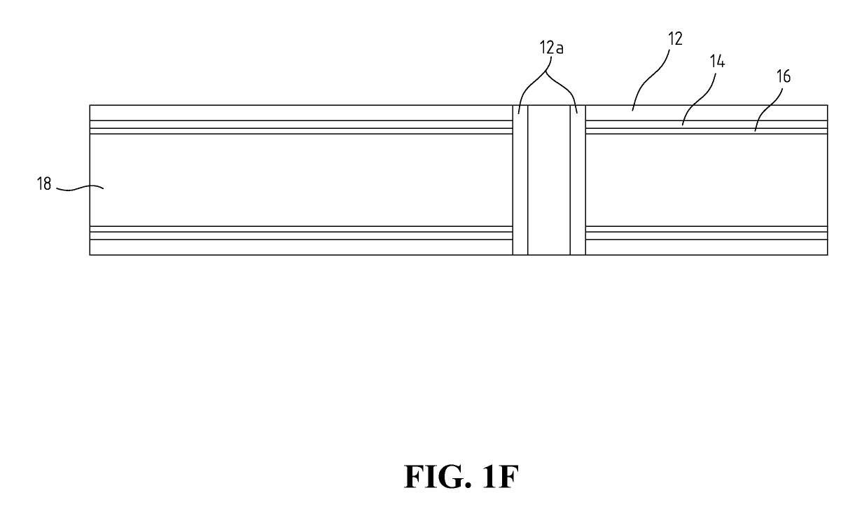

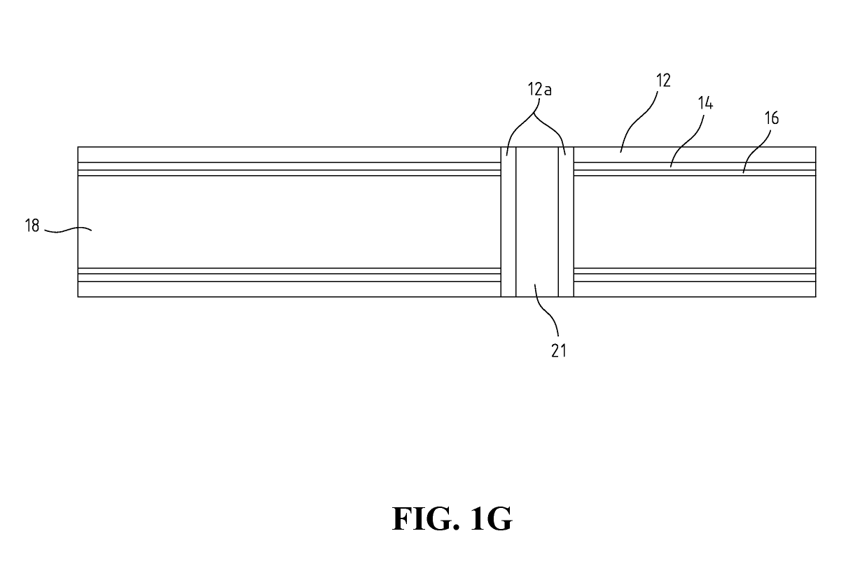

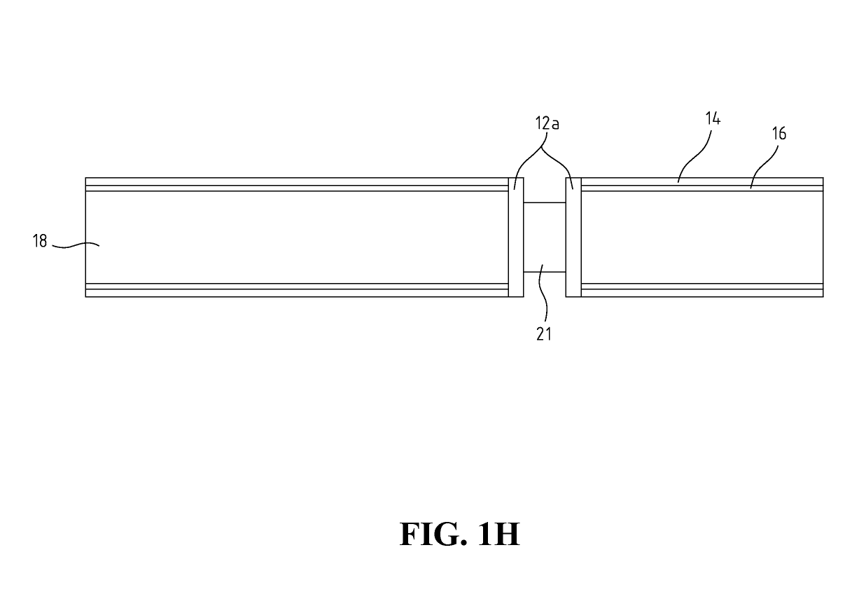

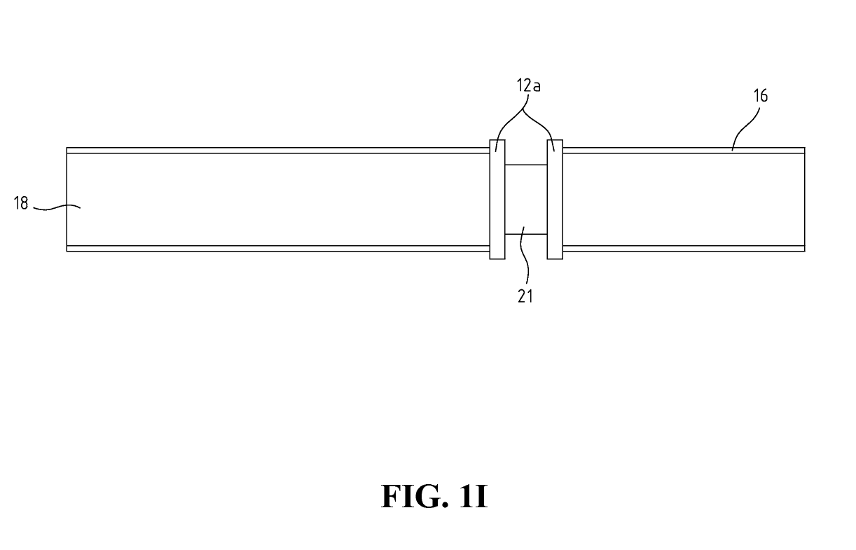

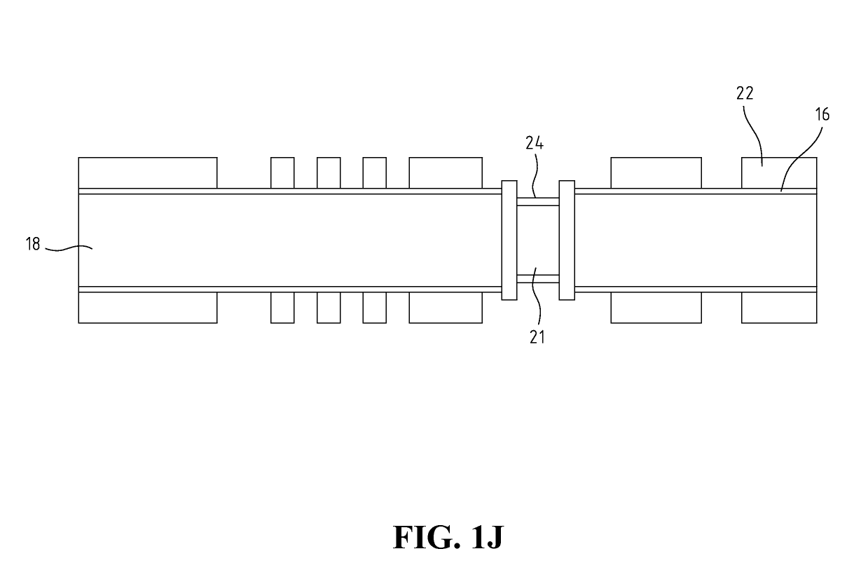

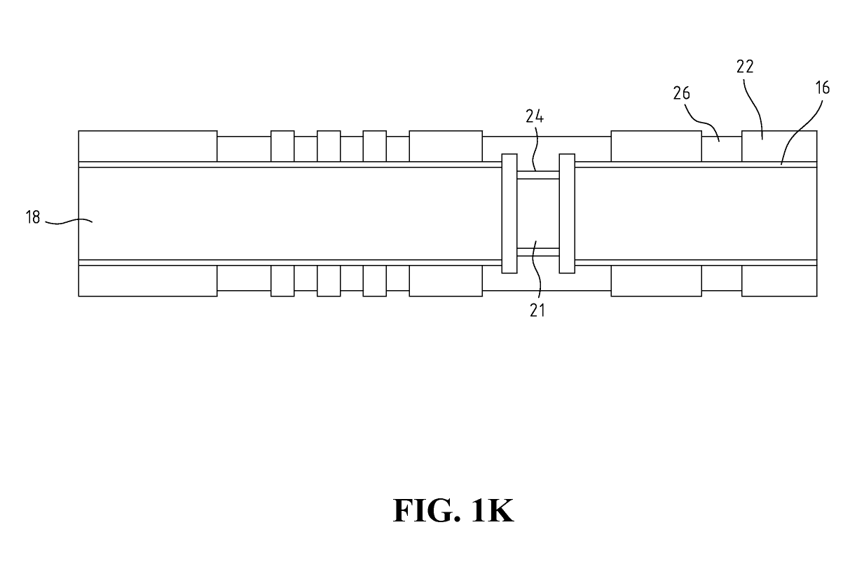

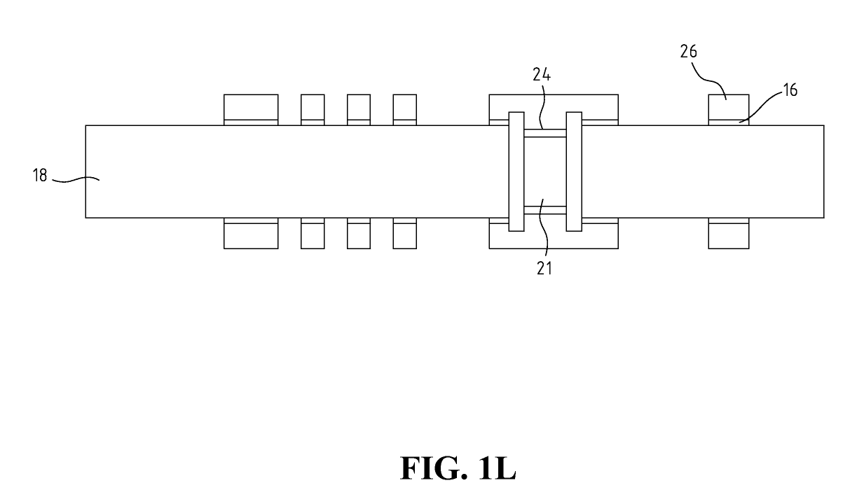

A method for fabricating a circuit trace on a core board having a buried hole according to the present invention includes the following steps. A carrier plate 10 is provided. Referring to FIGS. 1A-1B, a detachable metal layer 12 is formed on the carrier plate 10, an etching barrier layer 14 is formed on the detachable metal layer 12, and a metal layer 16 is formed on the etching barrier layer 14. Then, the metal layer 16 is roughened. The carrier plate 10, the detachable metal layer 12, the etching barrier layer 14, and the metal layer 16 are made of a conductive material, copper, nickel, and copper, respectively. Surfaces of the metal layer 16 are easy to roughen.

Referring to FIG. 1C, the metal layer 16 faces with a dielectric (prepreg) 18, and then the bonded metal layer 16, the etching barrier layer 14, the detachable metal layer 12, and the carrier plate 10, is pressed to bond with the dielectric (prepreg) 18. Referring to FIG. 1D, the carrier plate 10 is detached from the bonded carrier plate 10, the detachable metal layer 12, the etching barrier layer 14, the metal layer 16, and the dielectric (prepreg) 18.

Further, referring to FIG. 1E, a through hole 20 is formed through the bonded detachable metal layer 12, the etching barrier layer 14, the metal layer 16, and the dielectric 18. Referring to FIG. 1F, a first plating metal layer 12a is plated on a side wall of the through hole 20. The first plating metal layer 12a is made of copper and formed by an electroless plating process. Then, as shown in FIG. 1G, the through hole 20 is filled with a resin filler 21. Referring to FIG. 1H, part of the resin filler 21 is removed. The detachable metal layer 12 and a portion of the first plating layer 12a that is beside the detachable metal layer 12 are removed from the etching barrier layer 14. As further shown in FIG. 11, the etching barrier layer 14 is removed from the metal layer 16. Thus, the metal layer 16 is exposed. Then, as shown in FIG. 1J, an electroless plating metal layer 24 is formed on the resin filler 21, and a patterning photo-resist layer 22 is formed on the metal layer 16. Referring to FIG. 1K, a second plating metal layer 26 is formed on the first plating metal layer 12a, the electroless plating metal layer 24 and a portion of the metal layer 16 where the patterning photo-resist layer 22 is not formed thereon. The patterning photo-resist layer 22 has a pattern corresponding to an unwanted portion of the metal layer 16. The second plating metal layer 26 has a pattern corresponding to a desired portion of the metal layer 16, i.e. the circuit trace on the core board.

As shown in FIG. 1L, the patterning photo-resist layer 22 is removed from the metal layer 16 and thus a part of the metal layer 16 that was disposed under the patterning photo-resist layer 22 is exposed. Then, the exposed part of the metal layer 16 is removed from the dielectric 18 and thus a part of the dielectric 18 that was disposed under the patterning photo-resist layer 22 is exposed. Therefore, the second plating metal layer 26 and a part of the metal layer 16 disposed under the second plating metal layer 26 are remained on the dielectric 18 to form a circuit layer.

The method according to the present invention includes the steps of providing a laminate that has the metal layer 16, the etching barrier layer 14, the detachable metal layer 12, and the carrier plate 10; roughening the metal layer 16; bonding the laminate with the dielectric 18 while the metal layer 16 facing with the dielectric 18. Because the metal layer 16 is a layer of the laminate, the metal layer 16 can be configured as thin as possible and is easy to roughen the surface thereof. Even if the dielectric 18 is made of a material that is hard to roughen, the roughened metal layer 16 still can provide a secure bonding between the metal layer 16 and the dielectric 18. Referring to FIGS. 1A-1L, the circuit trace may be fabricated on both sides of the dielectric 18 by the method according to the present invention.

According to an aspect of the present invention, a roughening processing or a passivation processing can be applied to all or part of the metal layer 16. The passivation processing can be a brown oxide treatment, a red oxide treatment, or a black oxide treatment. A surface, which is processed by the brown oxide treatment or the black oxide treatment, may further be processed by a plasma treatment. After being processed by the roughening processing or the passivation processing, the surface has a roughness of 0.4 to 0.5 μm.

According to another aspect of the present invention, the black oxide treatment is controlled by some parameters, including micro-etching thickness, pre-immersion temperature, concentration of AB solution used for black oxide treatment, proportion of the AB solution, processing time, and ageing of bath content. The thickness of the black oxidized portion is controlled by the bath content and the micro-etching thickness. The pre-immersion before the black oxide treatment is processed under a temperature from 30° C. to 40° C. for 1 to 2 minutes. The pre-immersion temperature should not be at the room temperature. This is subject to ensuring color evenness of the black oxide and avoiding color difference caused by the black oxide treatment. The compact and color evenness of the generated black oxidization film depends on proportion and concentration of the black oxidization solution. The bathing time and aging of the bath content affect lengths of crystals and physical characteristics of the crystallized black oxidization film. The black oxidization layer is a needle crystal layer. If a time to black oxidize the metal layer 16 is too short, the needle crystals are too short. The bonding between the metal layer 16 and the dielectric 18 is not strong enough. On the contrary, if a time to black oxidizes the metal layer 16 is too long, the needle crystals grow too long and becomes brittle, which weakens the bonding between the metal layer 16 and the dielectric 18. If the bath content is over aged, the needle crystals are also likely to grow too long, become brittle, and even form a powdered surface. Thus, the bonding between the metal layer 16 and the dielectric 18 is weakened. If the needle crystals are too long, the needle crystals break under pressure, flow with adhesive, and sometimes even exposed from edges of the metal layer 16 after bonding the metal layer 16 with the dielectric 18.

In general, the black oxidization layer includes more univalent copper, while a brown oxidization layer includes more bivalent copper. Therefore, the brown oxidization layer is more stable than the black oxidization layer. However, both of the oxidization layers need to be processed in a bath content for 3 to 5 minutes under 80 to 90° C. Therefore, both of the oxidization layers are inconvenient to process, have a risk of deformation, and sometimes even generate a pink-ring. Therefore, according to another aspect of the present invention, the copper surface can be processed with a micro-roughening process for obtaining an optimal bondability. Other roughening processes, such as micro-brushing and micro-etching can also be adopted hereby.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for fabricating a circuit trace on a core board having a buried hole, comprising:
providing a carrier plate having a detachable metal layer plated thereon;
forming an etching barrier layer on the detachable metal layer;
forming a metal layer on the etching barrier layer, wherein the metal layer is adapted to be patterned to be a circuit layer;
roughening the metal layer;
laminating the bonded metal layer, the etching barrier layer, the detachable metal layer and the carrier plate onto a dielectric, wherein the metal layer faces and contacts with the dielectric; and
removing the carrier plate from the bonded metal layer, the etching barrier layer, the detachable metal layer and the carrier plate.

2. The method according to claim 1, wherein the carrier plate is made of a conductive material.

3. The method according to claim 1, wherein the detachable metal layer is made of copper.

4. The method according to claim 1, wherein the etching barrier layer is made of nickel.

5. The method according to claim 1, wherein the metal layer is made of copper.

6. The method according to claim 1, wherein the dielectric is made of a material that is difficult to roughen.

7. The method according to claim 1, further comprising:
forming a through hole through the detachable metal layer, the etching barrier layer, the metal layer, and the dielectric;
plating a first plating metal layer on a side wall of the through hole;
filling the through hole with a resin filler;
removing the detachable metal layer and a portion of the first plating metal layer that is beside the detachable metal layer, and then removing the etching barrier layer away from the metal layer to expose the metal layer;
forming an electroless plating metal layer on the resin filler;
forming a patterning photo-resist layer on the metal layer;
forming a second plating metal layer on the electroless plating metal layer and a portion of the metal layer where the patterning photo-resist layer is not formed thereon;
removing the patterning photo-resist layer and exposing a portion of the metal layer disposed under the patterning photo-resist layer; and
removing the exposed portion of the metal layer so as to expose the dielectric disposed under the patterning photo-resist layer;
wherein a remained portion of the metal layer and the second plating metal layer formed thereon are the circuit layer.

8. The method according to claim 7, wherein the first plating metal layer is made of copper and formed by an electroless plating process.
